(19) United States
(12) Patent Application Publication
(10) Pub. No.: US 2026/0169160 A1
(43) Pub. Date: Jun. 18, 2026

(54) Hybrid Waveform Optimization

(71) Applicant: Google LLC, Mountain View, CA (US)

(72) Inventors: Octavio Ponce Madrigal, Mountain View, CA (US); Xin Hua, Santa Clara, CA (US)

(73) Assignee: Google LLC, Mountain View, CA (US)

(21) Appl. No.: 18/851,029

(22) PCT Filed: Oct. 6, 2023
(86) PCT No.: PCT/US2023/076280

§ 371 Date: Sep. 25, 2024

(51) Int. Cl. G01S 15/42; G01S 15/04; G01S 15/58

(52) U.S. Cl. CPC G01S 15/42; G01S 15/04; G01S 15/586

(57) ABSTRACT

This document describes systems and techniques for hybrid waveform optimization. In aspects, a computing device emits a hybrid waveform having overlapping up-chirp and down-chirp waveforms to create a continuous waveform that mitigates undesirable clicking sounds. The device may be configured to process reflections of the up-chirp waveforms and/or down-chirp waveforms to discern presence, proximity, relative movement, and/or another aspect of an object. An amplitude of the up-chirp and/or down-chirp waveforms may be scaled where the waveforms overlap so that an amplitude of the hybrid waveform is limited to fluctuate between a lower amplitude limit and an upper amplitude limit.

### BACKGROUND

Ultrasound signals are useful for imaging, motion detection, proximity detection, and other applications. Up-chirp and down-chirp waveforms, in which frequency of a signal within a single pulse is modulated from a low frequency to a high frequency or from a high frequency to a low frequency, respectively, may be particularly useful for detection applications. Up-chirp and down-chirp waveforms allow for accurate range determination and/or enable simultaneous resolution of heading and range of an object relative to the emitter and receiver of signals including the waveforms.

However, for some applications, signals including up-chirp and down-chirp waveforms may present some disadvantages. For example, ultrasonic up-chirp and down-chirp signals may result in clicking sounds that are audible to humans and/or detectable by audio devices such as microphones of mobile telephones or other devices with audio inputs. The clicking may be undesirable to users and may result in noise that is disruptive to communications carriers.

### SUMMARY

This document describes systems and techniques for hybrid waveform optimization. In aspects, a computing device emits a hybrid waveform having overlapping up-chirp and down-chirp waveforms to create a continuous waveform that mitigates undesirable clicking sounds. The device may be configured to process reflections of the up-chirp waveforms and/or down-chirp waveforms to discern presence, proximity, relative movement, and/or another aspect of an object. The amplitude of the up-chirp and/or down-chirp waveforms may be scaled where the waveforms overlap so that an amplitude of the hybrid waveform is limited to fluctuate between a lower amplitude limit and an upper amplitude limit.

For example, a mobile telephone may emit the hybrid waveform via an audio output component of the mobile telephone, such as a speaker, and receive reflections of the hybrid waveform via an audio input component, such as a microphone. By processing input audio signals received via the microphone, without adding additional hardware, the mobile telephone can measure proximity of a stationary object or a changing proximity of an object moving relative to the mobile telephone. Based on the proximity, one or more systems or functions of the mobile telephone may be activated or deactivated.

This Summary is provided to introduce systems and techniques for hybrid waveform optimization, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for hybrid waveform optimization are described in this document with reference to the following drawings. The same numbers are used throughout the drawings to reference like features and components:

FIG. 1 illustrates an example implementation of an apparatus emitting up-chirp or down-chirp waveforms that are discernible by a user;

FIG. 2 illustrates an example implementation of an apparatus that is configured to emit a hybrid waveform that is used to support applications such as proximity detection of a user;

FIG. 3 illustrates apparatuses capable of implementing hybrid waveform optimization in accordance with one or more implementations;

FIG. 4 illustrates graphs in time and frequency domains of a first waveform including an up-chirp waveform and a second waveform including a down-chirp waveform combined to form a hybrid waveform;

FIG. 5 illustrates example graphs in a time domain in which an amplitude of an up-chirp waveform and a down-chirp waveform of FIG. 4 are scaled to form a hybrid waveform having a composite amplitude within lower and upper amplitude limits;

FIG. 6 illustrates example graphs in time and frequency domains of a first waveform including a down-chirp waveform and a second waveform including an up-chirp waveform combined and scaled in amplitude to form a hybrid waveform;

FIGS. 7A and 7B illustrates an example mobile telephone that is configured to emit, receive, and process hybrid waveforms;

FIG. 8 illustrates an example mobile telephone including an optical sensor and/or a body heat sensor used along with input audio signals in determining a proximity of the mobile telephone to the user;

FIGS. 9-15 illustrate schematic diagrams of devices configured to emit output audio signals including a hybrid waveform and respond to input audio signals to determine a presence, proximity, relative movement, and/or another aspect of an object;

FIG. 16 illustrates a flow diagram of an example method of emitting output audio signals including a hybrid waveform, receiving input audio signals including reflections of the hybrid waveform, and processing input audio signals to determine a presence, proximity, and/or relative movement of an object.

### DETAILED DESCRIPTION

### Overview

Waveforms including up-chirp or down-chirp pulses are useful to determine a proximity of and/or to track a relative movement of an object. For example, up-chirp or down-chirp waveforms (e.g., in the ultrasonic frequency range) might be used by a mobile telephone to determine a proximity of the mobile telephone to a user's body. Based on the proximity detection, the mobile telephone can, in one example, lock an interactive display before the telephone is pressed to the user's ear to prevent inadvertent engagement with content on the interactive display, which may cause call disconnection or other undesirable actions. Users generally appreciate services made available by this proximity detection using up-chirp and down-chirp waveforms.

However, up-chirp or down-chirp waveforms may result in audible clicking sounds between chirped pulses, for example. These clicking sounds might be discernible by the user of the telephone or a party on the line. These clicking sounds also might result in the mobile telephone not conforming with noise limitations imposed by a cellular carrier.

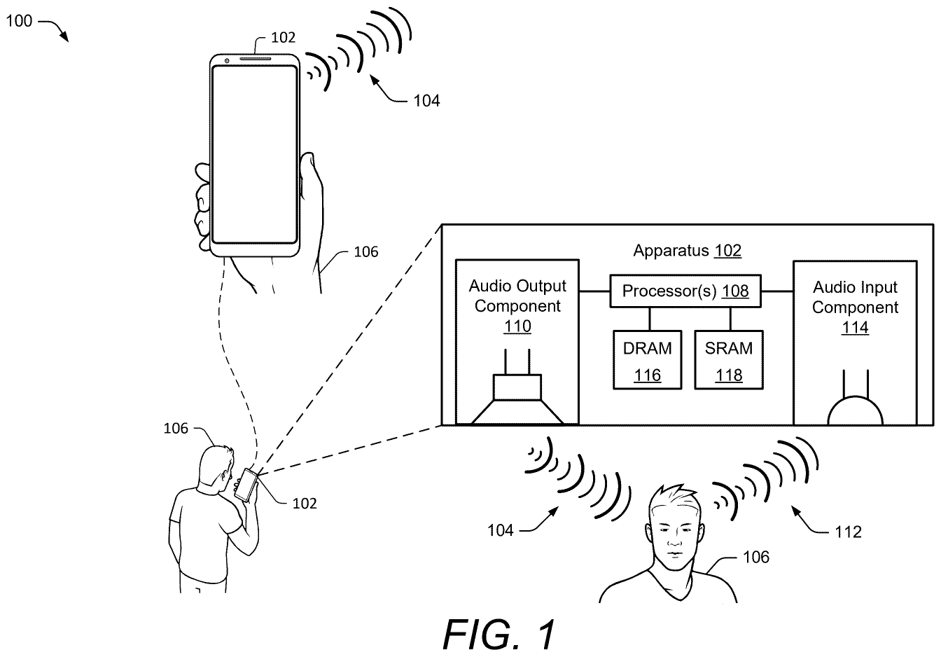

Consider FIG. 1, which illustrates an example implementation 100 of an apparatus 102 emitting up-chirp or down-chirp waveforms 104 that are discernible by a user 106. As illustrated, the apparatus 102 (e.g., a smartphone) emits the up-chirp and/or down-chirp waveforms 104 for proximity detection. These up-chirp and/or down-chirp waveforms 104 may be emitted, at an instruction of one or more processors 108, by an audio output component 110, resulting in reflected waveforms 112 being received at an audio input component 114. Although the up-chirp and/or down-chirp waveforms 104 may be configured to propagate within the ultrasonic frequency range, clicking noises may still be discernible by the user 106. These clicking noises may frustrate the user 106. In some instances, clicking sounds can also arise from saturating the dynamic range of the audio output component 110. Thus, the frequency of the waveforms 104 may be selected to avoid dynamic range saturation. The waveforms 104 may be stored within the apparatus 102 in dynamic random-access memory (DRAM) 116 and/or static random-access memory (SRAM) 118 accessible by the processor 108. In one example, the waveform 104 may be generally maintained in DRAM 116 but transferred to SRAM 118 during a call from which the waveform 104 may be continually retrieved for generation by the audio output component 110.

To this end, this document describes systems and techniques for hybrid waveform optimization. In aspects, a computing device emits a hybrid waveform having overlapping up-chirp and down-chirp waveforms to create a continuous waveform that mitigates undesirable clicking sounds. The device may be configured to process reflections of the up-chirp waveforms and/or down-chirp waveforms to discern presence, proximity, relative movement, and/or another aspect of an object. The amplitude of the up-chirp and/or down-chirp waveforms may be scaled where the waveforms overlap so that an amplitude of the hybrid waveform is limited to fluctuate between a lower amplitude limit and an upper amplitude limit.

### Operating Environment

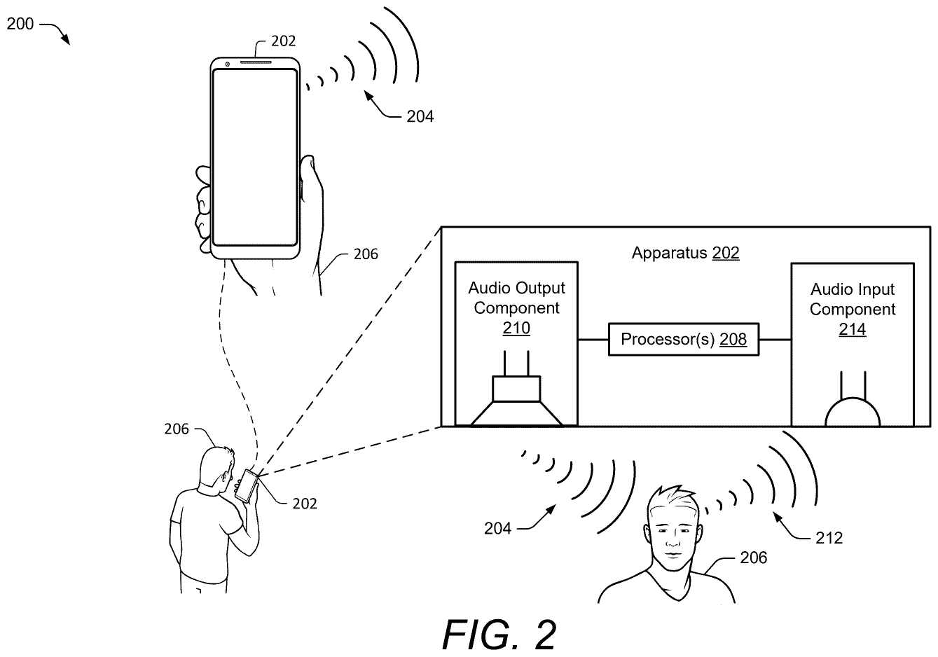

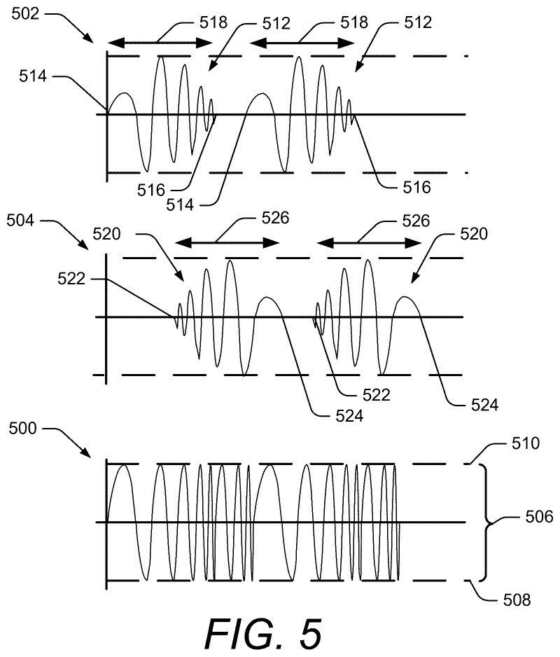

FIG. 2 illustrates an example implementation 200 of an apparatus 202 that is configured to emit a hybrid waveform 204 that is used to support applications such as proximity detection of a user 206. As illustrated, the apparatus 202 (e.g., a smartphone) includes one or more processors 208, an audio output component 210 (e.g., a speaker), and an audio input component 214 (e.g., a microphone). At an instruction of the one or more processors 208, the audio output component 210 may emit output audio signals that include the hybrid waveform 204. The hybrid waveform 204 may include one or more overlapping up-chirp and down-chirp waveforms. The hybrid waveform 204 may reflect off at least one object, such as the user 206, resulting in a reflected hybrid waveform 212. The audio input component 214 may receive input audio signals that include the reflected hybrid waveform 212. The processor(s) 208 may process the input audio signals to detect and analyze the reflected hybrid waveform 212. Based on detected features of the reflected hybrid waveform 212, such as a detected magnitude, a Doppler shift, or so on, the processor(s) 208 may determine a proximity of the user 206. Based on the proximity of the user 206, the processor(s) 208 may control operations of the apparatus 202, as further described below with reference to FIGS. 5A-13.

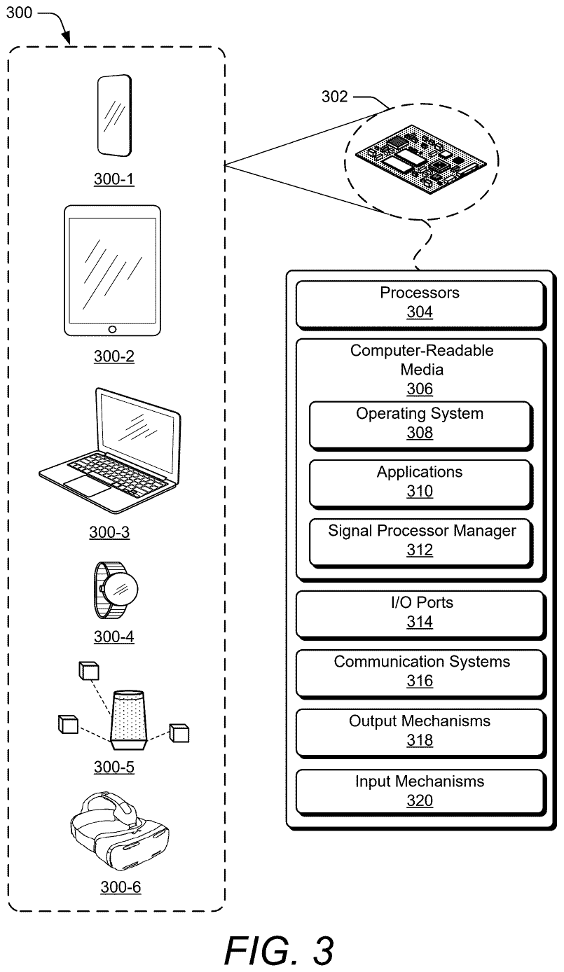

In more detail, FIG. 3 illustrates example apparatuses 300 (e.g., apparatus 202), which are capable of implementing hybrid waveform optimization in accordance with one or more implementations. Examples of an apparatus 300 include a smartphone 300-1, a tablet 300-2, a laptop 300-3, a smartwatch 300-4, mesh-network devices 300-5, and virtual-reality (VR) goggles 300-6. Although not shown, the apparatus 300 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an IoT device, security systems, and the like. Note that the apparatus 300 can be wearable, non-wearable but mobile, or relatively immobile (e.g., desktops, appliances). Further, the apparatus 300, in implementations, may be an implanted device (e.g., devices that are embedded in the human body), including radiofrequency identification (RFID) microchips, near-field communication (NFC) microchips, and so forth. Note also that the apparatus 300 can be used with, or embedded within, electronic devices or peripherals, such as in automobiles (e.g., steering wheels) or as an attachment to a laptop computer. The apparatus 300 may include components or interfaces omitted from FIG. 3 for the sake of clarity or visual brevity.

For example, although not shown, the apparatus 300 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

As illustrated, the apparatus 300 can include a printed circuit board assembly 302 (PCBA 302) on which components and interconnects of the apparatus 300 are embodied. Alternatively or additionally, components of the apparatus 300 can be embodied on other substrates, such as flexible circuit material or other insulative material, and, optionally, can be operatively coupled to the PCBA 302. The apparatus 300 can further include a housing that defines at least one internal cavity. The housing includes an exterior surface and an opposing interior surface. In some implementations, the exterior surface may include at least one portion in contact with a physical medium (e.g., hair, skin, tissue, clothing) associated with a user. For example, the smartwatch 300-4 can include an exterior surface in contact with a wrist of a user. In aspects, the housing may be any of a variety of plastics, metals, acrylics, or glasses. In an implementation, the exterior surface of the housing includes one or more channels (e.g., holes, ports). In some implementations, the housing may include and/or support a display, including an electroluminescent display (ELD), an active-matrix organic light-emitting diode display (AMOLED), a liquid crystal display (LCD), or the like. Although not illustrated, various other electronic components or devices can be housed in the internal cavity of the device. Generally, electrical components and electromechanical components of the apparatus 300 are assembled onto a printed circuit board (PCB) to form the PCBA 302. Various components of the PCBA 302 (e.g., processors and memories) are then programmed and tested to verify the correct function of the PCBA 302. The PCBA 302 is connected to or assembled with other parts of the apparatus 300 into a housing.

As illustrated, the apparatus 300 includes one or more processors 304 and computer-readable media 306. The processors 304 may include any suitable single-core or multi-core processor (e.g., an application processor (AP), a digital-signal processor (DSP), a central processing unit (CPU), a graphics processing unit (GPU)). The processors 304 may be configured to execute instructions or commands stored within the computer-readable media 306. The computer-readable media 306 can include an operating system 308, applications 310, and a signal processor manager 312. In at least some implementations, the operating system 308 and applications 310 implemented as computer-readable instructions in the computer-readable media 306 can be executed by the processors 304 to provide some or all of the functionalities described herein, such as some or all of the functions of the signal processor manager 312. The computer-readable media 306 may be stored within one or more storage devices (e.g., non-transitory storage devices) such as a random access memory (RAM, dynamic RAM (DRAM), non-volatile RAM (NVRAM), or static RAM (SRAM)), read-only memory (ROM), or flash memory, a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

The apparatus 300 may also include and/or be operatively coupled to input/output (I/O) ports 314. The I/O ports 314 allow the apparatus 300 to interact with other devices or users, conveying any combination of digital signals, analog signals, and radiofrequency (RF) signals. The I/O ports 314 may include any combination of internal or external ports, such as universal serial bus (USB) ports, audio ports, Serial ATA (SATA) ports, peripheral component interconnect express (PCI-express) based ports or card-slots, secure digital input/output (SDIO) slots, and/or other legacy ports. Various devices may be operatively coupled with the I/O ports 314, such as human-input devices (HIDs), external computer-readable storage media, or other peripherals.

The apparatus 300 may further include and/or be operatively coupled to communication systems 316. The communication systems 316 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication systems 316 may be packetized or framed depending on a communication protocol or standard by which the apparatus 300 is communicating. The communication systems 316 may include wired interfaces, such as Ethernet or fiber-optic interfaces for communication over a local network, a private network, an intranet, or the Internet. Alternatively, or additionally, the communication systems 316 may include wireless interfaces that facilitate communication over wireless networks, such as wireless LANs, cellular networks, or WPANs.

The apparatus 300 may also include, and/or be operatively coupled with, one or more output mechanisms 318. The output mechanisms 318 may include light-emitting diodes, audio output components (e.g., speakers), haptic feedback actuators, and so on. The apparatus 300 can further include, and/or be operatively coupled with, one or more input mechanisms 320. The input mechanisms 320 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), pressure-sensitive actuators, or an ambient light sensor (e.g., photodetector). In implementations, the apparatus 300 includes one or more of a front-facing image sensor(s) and a rear-facing image sensor(s).

### Example Hybrid Waveforms

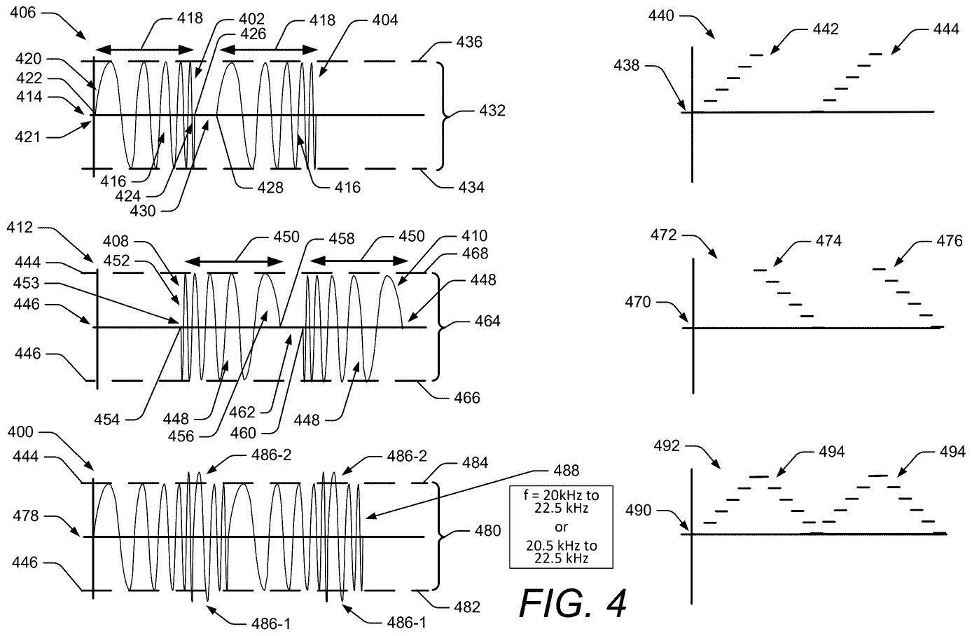

FIG. 4 illustrates an example hybrid waveform 400 that includes pulses 402 and 404 of a first waveform 406 and pulses 408 and 410 of a second waveform 412. In implementations, a first pulse 402 of the first waveform 406 includes an up-chirp waveform that, as shown in a time domain 414, has a first varying frequency 416 that increases in frequency during a first period 418 from a first high frequency 420 in a first phase 421 from a first origin 422 of the first pulse 402 to a first low frequency 424 at a first end 426 of the first pulse 402. A second pulse 404 of the first waveform 406 includes another up-chirp waveform identical to that of the first pulse 402 in its first period 418 and first varying frequency 416 from a second origin 428 separated by a gap 430 from the first end 426 of the first pulse 402. The pulses 402 and 404 each have a first amplitude 432 that fluctuates between a lower amplitude limit 434 and an upper amplitude limit 436. In a frequency domain 438, a frequency-domain representation 440 of the first pulse 442 and the second pulse 444 includes increasing ramp functions.

A first pulse 408 of the second waveform 412 includes a down-chirp waveform that, as shown in a time domain 446, has a second varying frequency 448 that decreases in frequency during a second period 450 from a second high frequency 452 in a second phase 453 from a first origin 454 of the first pulse 408 to a second low frequency 456 at a first end 458 of the first pulse 408. A second pulse 410 of the second waveform 412 includes another down-chirp waveform identical to that of the first pulse 408 in its second period 450 and second varying frequency 448 from a second origin 460 separated by a gap 462 from the first end 458 of the first pulse 408. The pulses 408 and 410 each have a second amplitude 464 that fluctuates between a lower amplitude limit 466 and an upper amplitude limit 468. In a frequency domain 470, a frequency-domain representation 472 of the first pulse 474 and the second pulse 476 include decreasing ramp functions.

In implementations, because the first waveform 406 and the second waveform 412 are selected to supplement gaps in the complementary waveform, the first period 418 of the pulses 402 and 404 of the first waveform 406 may be the same as the second period 450 of the pulses 408 and 410 of the second waveform 412, although the second period 450 of the pulses 408 and 410 of the second waveform 412 could also be shorter or longer than the first period 418 of the pulses 402 and 404 of the first waveform 406. Similarly, the first amplitude 432 of the first waveform 406 and the second amplitude 464 of the second waveform 412 may be equivalent. In addition, the first varying frequency 416 and the second varying frequency 448 may be inverses of each other so that portions of the pulses 408 and 410 of the second waveform 412 fill the gap 430 between the pulses 402 and 404 of the first waveform 406 and portions of the pulses 402 and 404 of the first waveform 406 can fill the gap 462 between the pulses 408 and 410 of the second waveform 412 as a result of their differing respective phases 421 and 453.

In aspects, the pulses 402 and 404 of the first waveform 406 and the pulses 408 and 410 of the second waveform 412 may be combined to form the hybrid waveform 400. The hybrid waveform 400 is a continuous waveform without the gaps 430 and 462 of the first waveform 406 and the second waveform 412, respectively. In a time domain 478, the hybrid waveform 400 has an amplitude 480 that fluctuates between a lower amplitude limit 482 and an upper amplitude limit 484. The hybrid waveform 400 may exceed the lower amplitude limit 482 at points 486-1 and may exceed the upper amplitude limit 484 at points 486-2, which may be adjusted as described with reference to FIG. 5. The first varying frequency 416 of the first waveform 406 and the second varying frequency 448 of the second waveform 412 are selected so that a varying frequency 488 of the hybrid waveform 400 may vary between, for example, 20 kHz and 22.5 kHz, which is an ultrasonic frequency. In implementations, the varying frequency 488 of the hybrid waveform 400 may propagate in a range above a human auditory range but within a range that may be generated by the audio output component 210 and may be detected by the audio input component 214 (see FIG. 2). Additionally or alternatively, the varying frequency 488 of the hybrid waveform 400 may vary between 20.5 kHz and 22.5 kHz to allow a margin between an upper end of the human auditory range and a lower frequency of the hybrid waveform 400. In a frequency domain 490, a frequency-domain representation 492 of the hybrid waveform 400 may include a series of triangular waveforms 494.

In implementations, the hybrid waveform 400 includes at least portions of both up-chirp and down-chirp waveforms; however, it should be noted that in processing input audio signals that include reflections of the hybrid waveform 400 (e.g., reflected hybrid waveform 212), at least portions of either the up-chirp or down-chirp waveforms may be evaluated to determine presence, proximity, relative movement, and/or another aspect of an object. For example, when a reflected hybrid waveform is processed, up-chirp components may be analyzed, while complementary down-chirp components may be disregarded. However, inclusion of the complementary down-chirp component in the hybrid waveform 400 is still significant in forming the hybrid waveform 400 so as to avoid clicking sounds or other undesirable effects. Correspondingly, when, for example, a reflected hybrid waveform is processed, down-chirp components may be analyzed, while complementary up-chirp components may be disregarded. However, inclusion of the complementary up-chirp component in the hybrid waveform 400 is still significant in forming the hybrid waveform 400 so as to avoid clicking sounds or other undesirable effects.

As previously described with reference to FIG. 4, combining up-chirp and down-chirp waveforms to form the hybrid waveform 400 may result in the hybrid waveform 400 of which the amplitude 480 may exceed the lower amplitude limit 482 at points 486-1 and may exceed the upper amplitude limit 484 at points 486-2. To prevent the hybrid waveform 400 from exceeding the lower amplitude limit 482 and/or the upper amplitude limit 484, which may potentially result in audible clicking sounds, a scaled hybrid waveform 500 may be formed of a combination of a first scaled waveform 502 (which, in the example of FIG. 3, includes an up-chirp waveform) and a second scaled waveform 504 (which, in the example of FIG. 3, includes a down-chirp waveform) so that a scaled amplitude 506 of the scaled hybrid waveform 500 does not transcend a lower amplitude limit 508 or an upper amplitude limit 510.

In more detail, FIG. 5 illustrates example graphs in a time domain in which amplitudes (amplitude 432, amplitude 464) of the up-chirp waveform 406 and the down-chirp waveform 412 of FIG. 4 are scaled to form the scaled hybrid waveform 500 having a composite amplitude within lower and upper amplitude limits. Pulses 512 of the first scaled waveform 502 are scaled in amplitude toward origins 514 and ends 516 of periods 518 of the pulses 512. Similarly, pulses 520 of the second scaled waveform 504 are scaled in amplitude toward origins 522 and ends 524 of periods 526 of the pulses 520. A resulting combination of the pulses 512 of the first scaled waveform 502 and the pulses 520 of the second scaled waveform 504 results in the scaled hybrid waveform 500 whose amplitude 506 fluctuates entirely within the lower amplitude limit 508 and the upper amplitude limit 510.

Consider FIG. 6, which illustrates example graphs in time and frequency domains of a first waveform including a down-chirp waveform and a second waveform including an up-chirp waveform combined and scaled in amplitude to form a hybrid waveform 600. In implementations, the hybrid waveform 600 may be formed of a first waveform 602 that includes down-chirp pulses 604 complemented by a second waveform 606 that includes up-chirp pulses 608. In a frequency domain 610, a representation 612 of the down-chirp pulses 614 includes a decreasing ramp function. In a frequency domain 616, a representation 618 of the up-chirp pulses 620 presents an increasing ramp function. Thus, when the first waveform 602 and the second waveform 604 are combined to form the hybrid waveform 600, in a frequency domain 622, a representation 624 includes a V-shaped waveform or an inverted triangular waveform.

Although the foregoing examples depict hybrid waveforms formed using up-chirp and down-chirp waveforms, implementations are not limited to these waveforms. For example, waveforms could include either linear or non-linear up-chirp and/or down-chirp waveforms. The constituent waveforms also may include pseudorandom binary sequence (PRBS) waveforms or any types of waveforms that may be combined to create a hybrid waveform as previously described. A hybrid waveform could be comprised of continuous signals, such as a frequency-modulated continuous waveform (FMCW), as well as of chirped waveforms as previously described. Similarly, although ultrasonic signals may be well-suited for some applications, as described below, implementations are not limited to any particular frequency or amplitude.

Implementations may utilize pulse-based or continuous signals. A pulse-based system may regularly but not continuously generate and process signals in which the pulses include a portion of the waveform. Pulse-based generation and processing consumes less processing power and, correspondingly, consumes less power. On the other hand, a system generating a continuous waveform and utilizing a longer period may offer an improved signal-to-noise ratio.

### Example Applications of Hybrid Waveforms

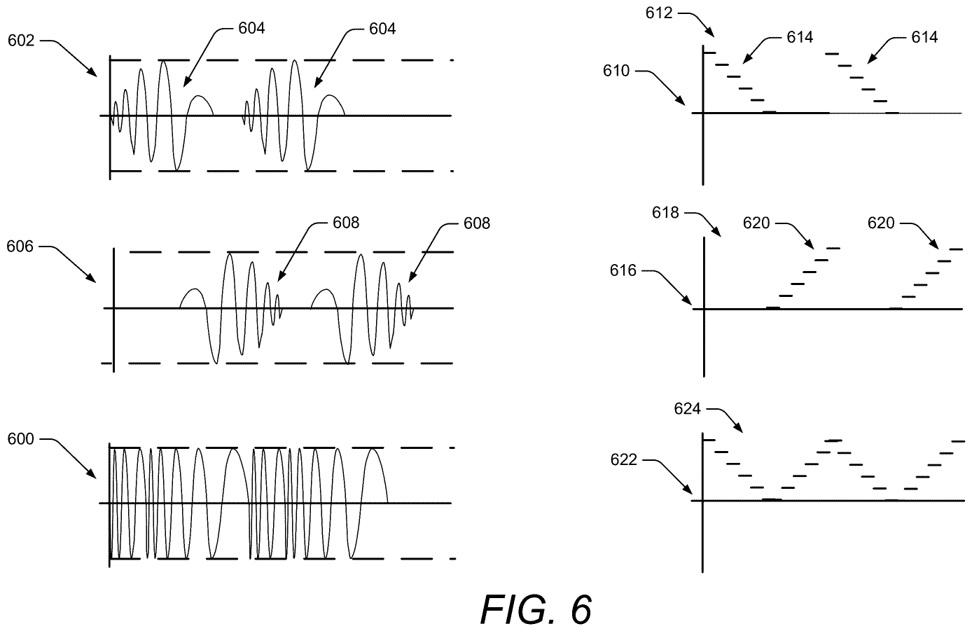

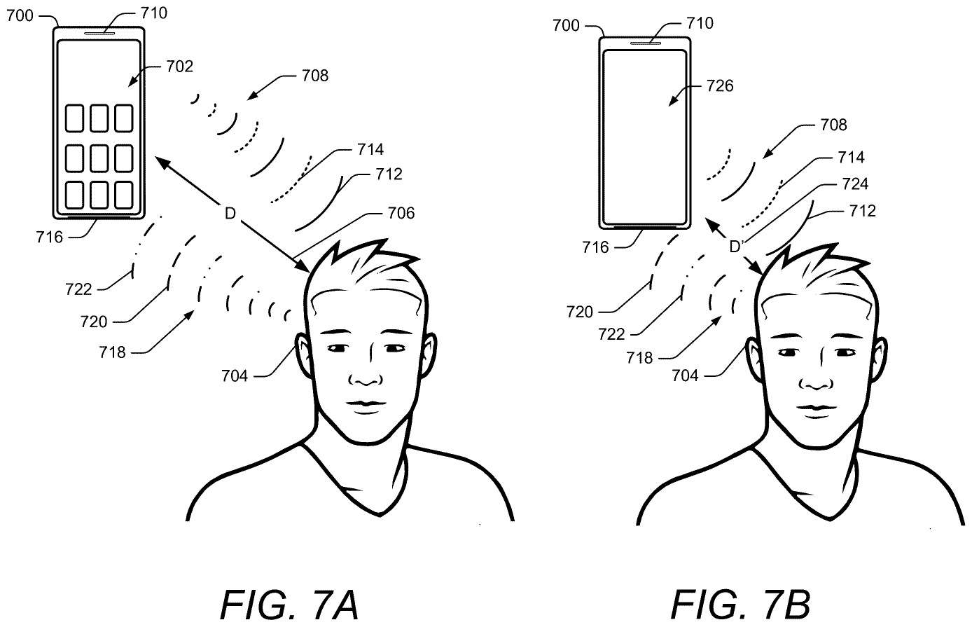

FIGS. 7A and 7B illustrate an example mobile telephone 700 (e.g., smartphone 300-1) that is configured to emit, receive, and process hybrid waveforms (e.g., hybrid waveform 400, scaled hybrid waveform 500, hybrid waveform 600). Referring to FIG. 7A, the mobile telephone 700 includes a display 702 and operates in an unlocked state. In implementations, when the mobile telephone 700 is removed from the user's body 704 (e.g., an ear), or another object associated with the user's body 704, by a distance D 706, the display 702 may be activated (e.g., present interactive graphical inputs), the mobile telephone 700 may permit input at a touchscreen, and/or one or more processors (e.g., processors 304) may initiate functions in response to input at the touchscreen. To determine the distance D 706, the mobile telephone 700 may emit output audio signals 708 from an audio output component 710 (e.g., output mechanisms 318). In implementations, the output audio signals 708 include both telephony output 712 (represented by solid lines), such as a voice of a caller, and a hybrid waveform 714 (represented by dotted lines) as previously described. An audio input component 716 (e.g., input mechanisms 320) of the mobile telephone 700 receives input audio signals 718. In implementations, the input audio signals 718 include both telephony input 720 (represented by dashed lines), such as a voice of a user of the mobile telephone 700, and a reflected hybrid waveform 722 (represented by dotted and dashed lines). The mobile telephone 700 processes the input audio signals 718 to determine, for instance, a proximity of the mobile telephone 700 to the user's body 704. In one example, the mobile telephone 700 utilizes one or more processors 304 (see FIG. 3) to execute the signal processor manager 312 to determine a proximity of the mobile telephone 700 to the user's body 704. For example, when the proximity between the mobile telephone 700 and the user's body 704 is at least the distance D 706, the mobile telephone 700 presents an activated display 702 that permits input at a touchscreen and/or initiates functions in response to input at the touchscreen.

Referring to FIG. 7B, when the mobile telephone 700 is moved within a predetermined proximity of the user's body 704, such as distance D′ 724, the mobile telephone 700 operates in a locked state, deactivating a display 726, preventing input at a touchscreen, and/or disabling functions in response to receiving input at the touchscreen. In the locked state, functions of the mobile telephone 700 may not be inadvertently activated by contact with the user's body 704 and may also reduce power consumption of the mobile telephone 700. As previously described, the hybrid waveform 714 may be included in the output audio signals 708 and received as part of the input audio signals 718 without affecting telephony audio signals. Because the hybrid waveform 714 and the reflected hybrid waveform 722 are continuous and may include no gaps between pulses, the hybrid waveform 714 and the reflected hybrid waveform 722 do not cause clicking sounds that may be heard by a user of the mobile telephone 700 or by a party on another end of a call. By generating the hybrid waveform 714 and the reflected hybrid waveform 722 in an ultrasonic range as described, the waveforms 714 and 722 may not be discernible by users or violate noise restrictions imposed by mobile telephone carriers.

In addition to conforming to carrier noise restrictions imposed by mobile carriers, hybrid waveforms as herein described also provide other advantages and/or avoid concerns of using signals to determine a presence, proximity, relative movement, or an aspect of an object in a mobile telephone. For example, a hybrid waveform that incorporates multiple frequencies may not be hampered by an audio output component 110 (see FIG. 1) that does not have a consistent acoustic frequency response. Thus, although usefulness of a waveform in a particular frequency range may be limited if the frequency response of the audio output component 110 is not well-suited to that frequency range, a waveform that spans multiple frequencies may not be limited by shortcomings in frequency response of the audio output device 110 or in the audio input component 114 receiving reflections of such signals.

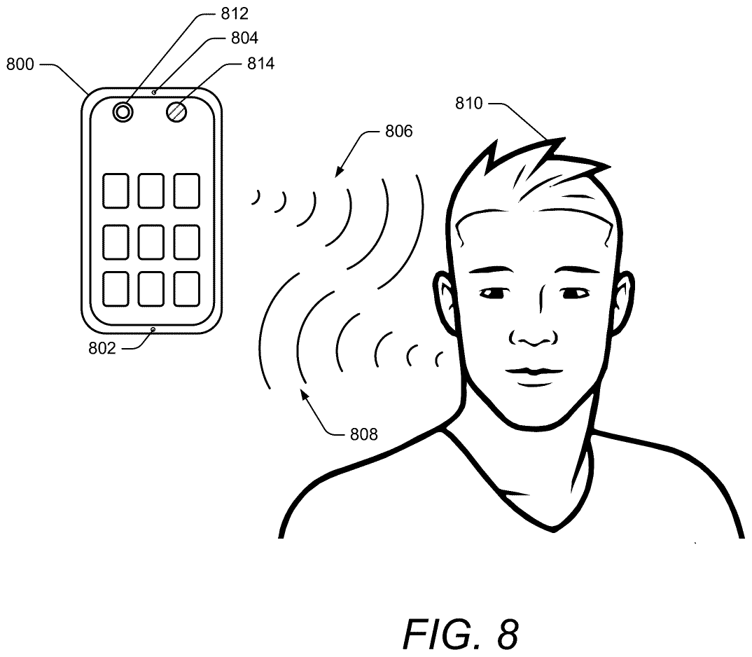

The mobile telephone 700 or another device may determine proximity of an object, such as a part of a user's body, by emitting, receiving, and processing a hybrid waveform alone as described with reference to FIGS. 7A and 7B. Additionally or alternatively, the use of the hybrid waveform may be combined within another technique for detecting proximity of a device to a physical object. Referring to FIG. 8, a device 800, which may be a mobile telephone or another electronic device, may include an audio input component 802 and an audio output component 804 configured to emit an output audio signal 806, including the hybrid waveform (not shown in FIG. 8), and the audio input component 802 may be configured to receive input audio signals 808. As described with reference to FIGS. 7A and 7B, the device 800 may process the input audio signals 808 to determine whether the input audio signals 808 include reflections of the output audio signals 806 that indicate proximity of an object 810, such as a user. The emitting of the output audio signals 806 and processing of the input audio signals 808 may constitute only one system used to determine a presence, proximity, relative movement, and/or another feature of the object 810.

For example, an optical system 812 may be included in the device 800 to identify a presence or proximity of the object 810. The optical system 812 may be a primary detection system for which the processing of the input audio signals 808 may be used for corroboration of determinations made by the optical system 812, or vice versa. Similarly, a body heat sensor 814 may be included in the device 800 to identify a presence or proximity of the object 810. The body heat sensor 814 may be a primary detection system for which the processing of the input audio signals 808 may be used for corroboration of determinations made by the body heat sensor 814, or vice versa. In additional or alternate implementations, a radar sensor may be included in the device 800 to identify a presence or proximity of the object 810. The radar sensor may be a primary detection system for which the processing of the input audio signals 808 may be used for corroboration of determinations made by the radar sensor, or vice versa. Alternatively, the device 800 may use the processing of the input audio signals 808 in combination with the optical system 812, the body heat sensor 814, the radar sensor, and/or other sensors to determine a presence, proximity, relative movement, and/or another feature of the object 810. For example, the sensors can determine a shape, orientation, size, contour, or other characteristics of the object 810.

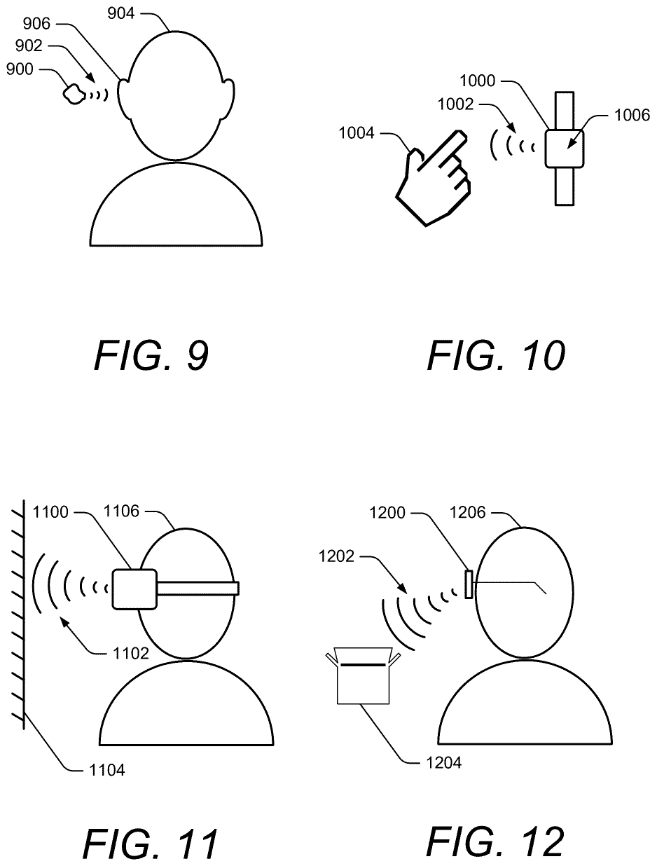

In addition to a mobile telephone, other devices may, in combination or isolation, emit, receive, and/or process a hybrid waveform to determine a presence, proximity, relative movement, and/or another aspect of an object. In FIGS. 9-12, devices are shown only as emitting output audio signals for the sake of clarity and conciseness. It will be appreciated, however, that the devices may further receive input audio signals and process the input audio signals, using the signal processor manager 312 executing on one or more processors 304, to detect a presence, proximity, relative movement, and/or another aspect of an object.

Referring to FIG. 9, an earbud 900 may emit output audio signals 902, including a hybrid waveform, to determine a presence or proximity of a user 904. In implementations, because the hybrid waveform is in an ultrasonic range of, for example, 20 kHz to 22.5 kHz or 20.5 kHz to 22.5 kHz above a human auditory range, the hybrid waveform included in the output audio signals 902 may not be detectable by the user 904, even in proximity to an ear 906 of the user 904. The output audio signals 902 may be used alone or in combination with another sensing device (not shown) to determine, for example, whether the earbud 900 is inserted into the user's ear 906 as based on a magnitude of the hybrid waveform or a return speed of the hybrid waveform. Thus, if the earbud 900 is removed from the ear 906, the earbud 900 may be configured to pause audio content included in the output audio signal 902, initiate a countdown to a battery-saving sleep or power-off cycle, or take other actions.

In applications involving a mobile telephone 700 or an earbud 900 as previously described, implementations of a hybrid waveform adhere to practical considerations. Although 20 kHz is generally regarded as the upper frequency limit of human hearing, many audio devices are configured to generate and/or receive signals between 20 kHz and 22.5 kHz, so a hybrid waveform within this range may be used with existing audio input and output devices without including additional circuitry or without being significantly blocked by low-pass filters that block signals in excess of 22 to 22.5 kHz. Correspondingly, received signals in the frequency range of 20 kHz to 22.5 kHz may be effectively sampled by a system that samples audio input signals at 48 kHz. In this range, signals may be emitted that detect proximity or presence of an object without exceeding 74.3 dBA, which could damage a user's hearing, while still maintaining a signal-to-noise ratio of 10 dB.

Referring to FIG. 10, a smartwatch 1000 may generate output audio signals 1002 to determine a presence or proximity of a user's hand 1004. In implementations, the output audio signals 1002 may solely include a hybrid waveform in an ultrasonic range and thus may not be detectable by a user. Input audio signals (not shown in FIG. 10) may be processed to determine a proximity or movement of the user's hand 1004 and, in response, engage an application of the smartwatch 1000. Thus, for example, a particular movement of the user's hand 1004 may activate a display 1006 of the smartwatch 1000, stop an alarm or timer, cause a music application to skip a next song, or cause some other function to be performed.

Referring to FIG. 11, virtual-reality (VR) goggles 1100 may generate output audio signals 1102 to determine a presence or proximity of an object 1104, such as a boundary of a use area or an object with which an application executing on the VR goggles 1100 may interact. Input audio signals (not shown in FIG. 11) may be processed to determine whether a user 1106 should be warned of their proximity to the object 1104 or whether an application executing on the VR goggles 1100 should otherwise trigger an event responsive to the presence or proximity of the object 1104. Similarly, referring to FIG. 12, augmented-reality (AR) glasses 1200 may generate output audio signals 1202 to determine a presence or proximity of an object 1204 with which an application executing on the AR goggles 1200 may interact. Input audio signals (not shown in FIG. 12) may be processed to determine whether a user 1206 should be informed of the presence or proximity of the object 1204. In both cases, the output audio signals 1102 and 1202 include the hybrid waveform in an ultrasonic range, and, thus, the hybrid waveform may not be detectable by the user 1106 and 1206, respectively, even though the output audio signals 1102 and 1202 are generated close to their ears.

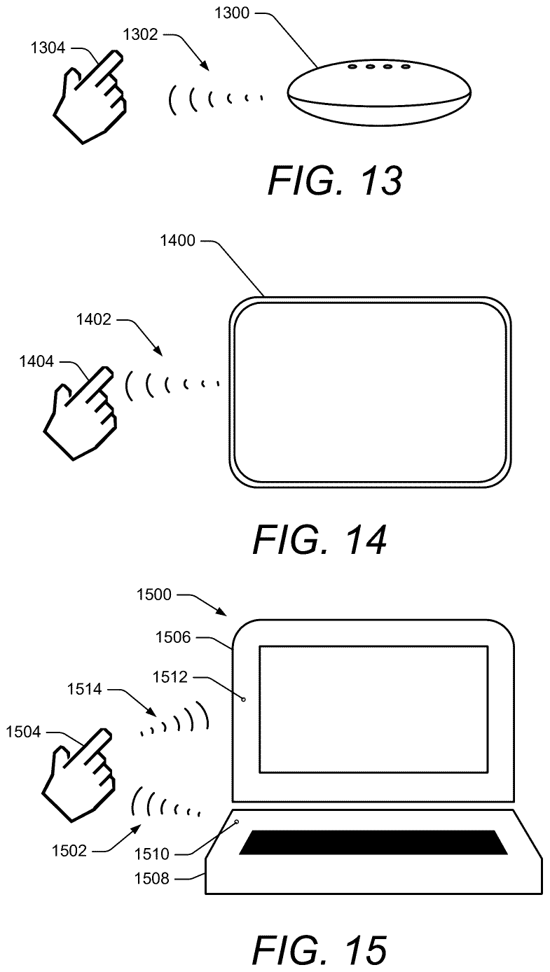

In addition to wearable devices using output audio signals including a hybrid waveform to determine a presence, proximity, relative movement, and/or another aspect of objects, stationary devices also may use output audio signals including a hybrid waveform to determine a presence, proximity, or movement of objects, such as users. For example, FIG. 13 illustrates a smart speaker 1300 that may generate output audio signals 1302 to determine a presence, proximity, or movement of a user's hand 1304 or another object. The smart speaker 1300 may be responsive to touch commands to stop an alarm, increase or decrease volume, or other functions. By using output audio signals 1302 including a hybrid waveform, without disturbing nearby persons or affecting music or other audio content included in the output audio signals 1302, a user may be able to control functions of the smart speaker 1300 by performing gestures in proximity to the smart speaker 1300 rather than by touching the smart speaker 1300.

FIG. 14 shows a smart display device 1400, which may include a smart clock, a tablet computer, a display of a laptop computer, a smart television, or a similar device configured to generate audio and/or video. The smart display device 1400 may generate output audio signals 1402 to determine a presence, proximity, or movement of a user's hand 1404 or another object. The smart display device 1400 may be responsive to touch commands or commands from a remote-control device (not shown) to increase or decrease volume, pause or play content, or other functions. By using output audio signals 1402 including a hybrid waveform, without disturbing nearby persons or affecting music or other audio content included in the output audio signals 1402, a user may be able to control functions of the smart display device 1400 by performing gestures in proximity to the smart speaker 1300 rather than by touching the smart display device 1400 or using a remote control device.

FIG. 15 illustrates a desktop computer 1500 configured to generate output audio signals 1502 including a hybrid waveform to respond to a presence, proximity, movement, or another aspect of a user's hand 1504 or another part of a user's body. The desktop computer 1500 is an example of a device that includes separate components, such as a display 1506 (or system unit with an integrated display) that is separate from a keyboard 1508. In such a device, a first device, such as the keyboard 1508, may include an audio output component 1510, such as a speaker, configured to generate the output audio signals 1502 including the hybrid waveform. A separate device, such as the display 1506, may include an audio input device 1512 configured to receive input audio signals 1514 that may include reflections of the output audio signals 1502 that include the hybrid waveform. Thus, two different devices, such as a first device in the form of the keyboard 1508 and a second device in the form of the display 1506, may incorporate the audio output component 1510 and the audio input device 1512, respectively, used to determine the presence, proximity, or movement of the user's hand 1504 or another object. The desktop computer 1500 may be configured, based on the presence, proximity, or movement of the user's hand 1504, to perform functions such as waking the desktop computer 1500, opening a browser, or other functions.

### Example Method

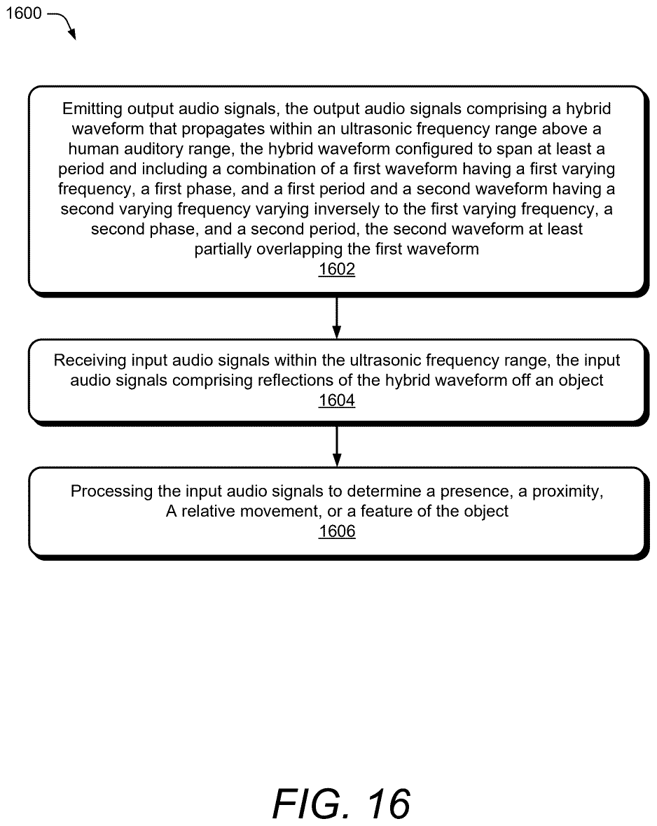

An example method 1600 is described with reference to FIG. 16 to illustrate an example method of generating output audio signals including a hybrid waveform and receiving and processing input audio signals including reflections of the hybrid waveform. At block 1602, output audio signals are emitted, the output audio signals comprising a hybrid waveform that propagates within an ultrasonic frequency range above a human auditory range. As described with reference to FIGS. 4-6, the hybrid waveform is configured to span at least a period and include a combination of a first waveform having a first varying frequency, a first phase, and a first period and a second waveform having a second varying frequency and a second phase varying inversely to the first varying frequency and a second period, with the second waveform at least partially overlapping the first waveform. At block 1604, input audio signals within the ultrasonic frequency range are received, the input audio signals comprising reflections of the hybrid waveform off an object as described with reference to FIGS. 2 and 7A-15, such as reflections from a part of a user's body or from a stationary object. At block 1606, the input audio signals are processed to determine a presence, proximity, relative movement, or another feature of the object, as also described with reference to FIGS. 2 and 7A-15. As a result, a device, such as a wearable or non-wearable device, may detect and respond to a presence, proximity, or movement of a user or other object without physical contact and by emitting output audio signals that do not include clicking sounds or otherwise interfere with audio or communications applications.

The preceding discussion describes systems and techniques for determining whether an earbud is removed from an ear of a user. These systems and techniques may be realized using one or more of the entities or components shown in or methods described with reference to FIGS. 2-15, which may be further divided, combined, and so on. Thus, these Figures illustrate some of the many possible systems capable of employing the described techniques.

### Additional Examples

In the following section, additional examples are provided.

Example 1: A method comprising: emitting output audio signals, the output audio signals comprising a hybrid waveform that propagates within an ultrasonic frequency range, the hybrid waveform configured to span at least a period and including a combination of: a first waveform having a first varying frequency, a first phase, and a first period; and a second waveform having a second varying frequency varying inversely to the first varying frequency, a second phase, and a second period, the second waveform at least partially overlapping the first waveform; receiving input audio signals within the ultrasonic frequency range, the input audio signals comprising reflections of the hybrid waveform off an object; and processing the input audio signals to determine a presence, a proximity, a relative movement, or a feature of the object.

Example 2: The method of example 1, wherein: the first waveform includes an up-chirp waveform, wherein the first varying frequency increases during the first period from a first low frequency to a first high frequency; and the second waveform includes a down-chirp waveform, wherein the second varying frequency decreases during the second period from a second high frequency to a second low frequency.

Example 3: The method of example 1, wherein: the first waveform comprises a down-chirp waveform, wherein the first varying frequency decreases during the first period from a first high frequency to a first low frequency; and the second waveform includes an up-chirp waveform, wherein the second varying frequency increases during the second period from a second low frequency to a second high frequency.

Example 4: The method of example 1, wherein an amplitude of the hybrid waveform is scaled such that the hybrid waveform fluctuates between a lower amplitude limit and an upper amplitude limit.

Example 5: The method of example 4, wherein at least one of a first amplitude of the first waveform or a second amplitude of the second waveform is scaled in a portion of the hybrid waveform in which the second waveform is at least partially overlapping the first waveform so that a composite amplitude of the hybrid waveform does not transcend the lower amplitude limit and the upper amplitude limit.

Example 6: The method of example 1, wherein the first varying frequency and the second varying frequency each have at least one of: a minimum frequency of at least 20 kHz; a minimum frequency of at least 20.5 kHz; or a maximum frequency of not more than 22.5 kHz.

Example 7: The method of example 1, further comprising: emitting the output audio signals via an audio output component; and receiving the input audio signals via an audio input component.

Example 8: The method of example 7, wherein: the audio output component comprises a speaker within a mobile telephone and the audio input component comprises a microphone within the mobile telephone; the output audio signals comprise telephony output that propagates within a frequency range in a human auditory range; and the input audio signals comprise telephony input that propagates within a frequency range in the human auditory range.

Example 9: The method of example 8, wherein the object comprises a body of a user, the method further comprising at least one of: activating one or more systems of the mobile telephone based on a proximity to the body of the user being within a threshold distance; or deactivating one or more systems of the mobile telephone based on the proximity to the body of the user being outside of the threshold distance.

Example 10: The method of example 9, further comprising: determining the proximity to the body of the user using at least one of an optical sensor or a body heat sensor, and wherein activating or deactivating one or more systems is further based on the determination of the proximity using at least one of the optical sensor or the body heat sensor.

Example 11: The method of example 7, wherein the audio output component and the audio input component are associated with a wearable apparatus, the wearable apparatus comprising a wireless earbud, virtual-reality goggles, augmented-reality glasses, or a smartwatch.

Example 12: The method of example 7, wherein the audio output component and the audio input component are associated with a smart clock, a tablet computer, a smart television, a laptop computing device, a desktop computing device, or a smart speaker.

Example 13: The method of example 7, wherein the audio output component is incorporated in a first device and the audio input component is incorporated in a second device.

Example 14: An apparatus comprising means for performing a method of any one of examples 1-13.

Example 15: A computer-readable storage medium comprising instructions that, when executed by one or more processors, cause the one or more processors to execute the method of any one of examples 1-13.

Example 16: An apparatus comprising: a storage device maintaining a hybrid waveform, the hybrid waveform spanning a period and including an overlapping combination of: a first waveform having a first varying frequency, a first phase, and a first period; and a second waveform having a second varying frequency varying inversely to the first varying frequency, a second phase, and a second period, the second waveform at least partially overlapping the first waveform; an audio output component configured to generate output audio signals in a frequency range that includes frequencies within a human auditory range and above the human auditory range and to output the hybrid waveform; an audio input component configured to receive input audio signals at the frequencies within the frequency range including return audio signals resulting from reflections of the hybrid waveform from an object; and a processor configured to process the return audio signals to determine a presence, proximity, relative movement, and/or another feature of the object.

Example 17: The apparatus of example 16, wherein: the first waveform includes an up-chirp waveform, wherein the first varying frequency increases during the first period from a first low frequency to a first high frequency; and the second waveform includes a down-chirp waveform, wherein the second varying frequency decreases during the second period from a second high frequency to a second low frequency.

Example 18: The apparatus of example 16, wherein: the first waveform comprises a down-chirp waveform, wherein the first varying frequency decreases during the first period from a first high frequency to a first low frequency; and the second waveform includes an up-chirp waveform, wherein the second varying frequency increases during the second period from a second low frequency to a second high frequency.

Example 19: The apparatus of example 16, wherein an amplitude of the hybrid waveform is scaled such that the hybrid waveform fluctuates between a lower amplitude limit and an upper amplitude limit.

Example 20: The apparatus of example 19, wherein at least one of a first amplitude of the first waveform or a second amplitude of the second waveform is scaled in a portion of the hybrid waveform in which the second waveform is at least partially overlapping the first waveform so that a composite amplitude of the hybrid waveform does not transcend the lower amplitude limit and the upper amplitude limit.

Example 21: The apparatus of example 16, wherein the first varying frequency and the second varying frequency each have at least one of: a minimum frequency of at least 20 kHz; a minimum frequency of at least 20.5 kHz; or a maximum frequency of not more than 22.5 kHz.

Example 22: The apparatus of example 16, wherein the audio output generator includes a speaker and the audio input component includes a microphone.

Example 23: The apparatus of example 22, wherein the apparatus includes a mobile telephone and the speaker includes a mobile telephone speaker used for telephony audio output and the microphone includes a mobile telephone microphone used for telephony input.

Example 24: The apparatus of example 23, wherein the processor is configured to process the return audio signals to determine a proximity of the mobile telephone to a user's body and to activate or deactivate one or more systems of the mobile telephone based on the proximity to the user's body.

Example 25: The apparatus of example 24, wherein the mobile telephone further comprises an optical sensor in communication with the processor and configured to provide an additional determination of the proximity of the mobile telephone to the user's body.

Example 26: The apparatus of example 24 wherein the mobile telephone further comprises a body heat sensor in communication with the processor and configured to provide an additional determination of the proximity of the mobile telephone to the user's body.

Example 27: The apparatus of example 16, wherein the apparatus includes a wearable apparatus wherein the processor is configured to process the input audio signals to determine a proximity of the wearable apparatus to an external object, and wherein the wearable apparatus includes an earbud, virtual-reality goggles, augmented-reality glasses, or a smartwatch.

Example 28: The apparatus of example 16, wherein the apparatus includes a user device wherein the processor is configured to process the input audio signals to determine a proximity of the user device to an external object, and wherein the user device includes a computing device or a smart speaker.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for hybrid waveform optimization have been described in language specific to certain features and/or methods, the subject of the appended Claims is not necessarily limited to the specific features or methods described. Rather, the specific features and methods are disclosed as example implementations for hybrid waveform optimization.

1. A method comprising:
emitting output audio signals, the output audio signals comprising a hybrid waveform that propagates within an ultrasonic frequency range, the hybrid waveform configured to span at least a period and including a combination of:
a first waveform having a first varying frequency, a first phase, and a first period; and
a second waveform having a second varying frequency varying inversely to the first varying frequency, a second phase, and a second period, the second waveform at least partially overlapping the first waveform;
receiving input audio signals within the ultrasonic frequency range, the input audio signals comprising reflections of the hybrid waveform off an object; and
processing the input audio signals to determine at least one of a presence, a proximity, a relative movement, or a feature of the object.

2. The method of claim 1, wherein:
the first waveform includes an up-chirp waveform, wherein the first varying frequency increases during the first period from a first low frequency to a first high frequency; and
the second waveform includes a down-chirp waveform, wherein the second varying frequency decreases during the second period from a second high frequency to a second low frequency.

3. The method of claim 1, wherein:
the first waveform comprises a down-chirp waveform, wherein the first varying frequency decreases during the first period from a first high frequency to a first low frequency; and
the second waveform includes an up-chirp waveform, wherein the second varying frequency increases during the second period from a second low frequency to a second high frequency.

4. The method of claim 1, wherein an amplitude of the hybrid waveform is scaled such that the hybrid waveform fluctuates between a lower amplitude limit and an upper amplitude limit.

5. The method of claim 4, wherein at least one of a first amplitude of the first waveform or a second amplitude of the second waveform is scaled in a portion of the hybrid waveform in which the second waveform is at least partially overlapping the first waveform so that a composite amplitude of the hybrid waveform does not transcend the lower amplitude limit and the upper amplitude limit.

6. The method of claim 1, wherein the first varying frequency and the second varying frequency each have at least one of:
a minimum frequency of at least 20 kHz;
a minimum frequency of at least 20.5 kHz; or
a maximum frequency of not more than 22.5 kHz.

7. The method of claim 1, further comprising:
emitting the output audio signals via an audio output component; and
receiving the input audio signals via an audio input component.

8. The method of claim 7, wherein:
the audio output component comprises a speaker and the audio input component comprises a microphone;
the output audio signals comprise telephony output that propagates within a frequency range in a human auditory range; and
the input audio signals comprise telephony input that propagates within a frequency range in the human auditory range.

9. The method of claim 1, wherein the object comprises a body of a user, the method further comprising at least one of:
activating one or more systems of a mobile telephone based on a proximity to the body of the user being within a threshold distance; or
deactivating one or more systems of the mobile telephone based on the proximity to the body of the user being outside of the threshold distance.

10. The method of claim 9, further comprising:
determining the proximity to the body of the user using at least one of an optical sensor or a body heat sensor, and wherein activating or deactivating one or more systems is further based on the determination of the proximity using at least one of the optical sensor or the body heat sensor.

11. The method of claim 7, wherein the audio output component and the audio input component are associated with a wearable apparatus, the wearable apparatus comprising a wireless earbud, virtual-reality goggles, augmented-reality glasses, or a smartwatch.

12. The method of claim 7, wherein the audio output component and the audio input component are associated with a smart clock, a tablet computer, a smart television, a laptop computing device, a desktop computing device, or a smart speaker.

13. The method of claim 7, wherein the audio output component is incorporated in a first device and the audio input component is incorporated in a second device.

14. (canceled)

15. A computer-readable storage medium comprising instructions that, when executed by one or more processors, cause the one or more processors to perform operations including:
emitting output audio signals, the output audio signals comprising a hybrid waveform that propagates within an ultrasonic frequency range, the hybrid waveform configured to span at least a period, an amplitude of the hybrid waveform being scaled such that the hybrid waveform fluctuates between a lower amplitude limit and an upper amplitude limit, the hybrid waveform including a combination of:
a first waveform having a first varying frequency, a first phase, and a first period; and
a second waveform having a second varying frequency varying inversely to the first varying frequency, a second phase, and a second period, the second waveform at least partially overlapping the first waveform;
receiving input audio signals within the ultrasonic frequency range, the input audio signals comprising reflections of the hybrid waveform off an object; and
processing the input audio signals to determine at least one of a presence, a proximity, a relative movement, or a feature of the object.

16. The computer-readable storage medium of claim 15, wherein at least one of a first amplitude of the first waveform or a second amplitude of the second waveform is scaled in a portion of the hybrid waveform in which the second waveform is at least partially overlapping the first waveform so that a composite amplitude of the hybrid waveform does not transcend the lower amplitude limit and the upper amplitude limit.

17. The computer-readable storage medium of claim 15, wherein:
the first waveform includes an up-chirp waveform, wherein the first varying frequency increases during the first period from a first low frequency to a first high frequency; and
the second waveform includes a down-chirp waveform, wherein the second varying frequency decreases during the second period from a second high frequency to a second low frequency.

18. The computer-readable storage medium of claim 15, wherein:
the first waveform comprises a down-chirp waveform, wherein the first varying frequency decreases during the first period from a first high frequency to a first low frequency; and
the second waveform includes an up-chirp waveform, wherein the second varying frequency increases during the second period from a second low frequency to a second high frequency.

19. The computer-readable storage medium of claim 15, further comprising:
emitting the output audio signals via an audio output component; and
receiving the input audio signals via an audio input component.

20. The computer-readable storage medium of claim 19, wherein:
the audio output component comprises a speaker and the audio input component comprises a microphone;
the output audio signals comprise telephony output that propagates within a frequency range in a human auditory range; and
the input audio signals comprise telephony input that propagates within a frequency range in the human auditory range.

21. The computer-readable storage medium of claim 19, wherein the audio output component is incorporated in a first device and the audio input component is incorporated in a second device.
